(19) United States
(12) Patent Application Publication
(10) Pub. No.: US 2004/0141846 A1
(43) Pub. Date: Jul. 22, 2004

(54) Propeller and air plane combination and design

(76) Inventor: Robert Upchurch, Willingboro, NJ (US)

Correspondence Address: ROBERT UPCHURCH, 66 Balfour Lane, Willingboro, NJ, 08046, US

(21) Appl. No.: 09/999,910

(22) Filed: Jan. 16, 2003

(51) Int. Cl. F03B 3/12

(52) U.S. Cl. 416/170 R

(57) ABSTRACT

Propeller and airplane combination includes front and rear propeller blades, shafts, rotary wheels, rotary wheels belts, engines and hydraulic pressure tanks. The hydraulic pressure lift the shafts to upward direction, the bottom of the shafts connects to the engine rotary wheels and the rotary wheels belts rotate the front and rear shafts. The battery supply the electric power to start the engine, the front and rear shafts, upward direction and downward direction by hydraulic pressure and starting of the engine are all operated by the electric control box.

Be it known that I, Robert Upchurch, of Willingboro, in the county of Burlington and the State of New Jersey, have invented the new front and rear propeller blades, shafts and hydraulic pressure tanks, installation exclusively for all air planes, of which the following is a specification.

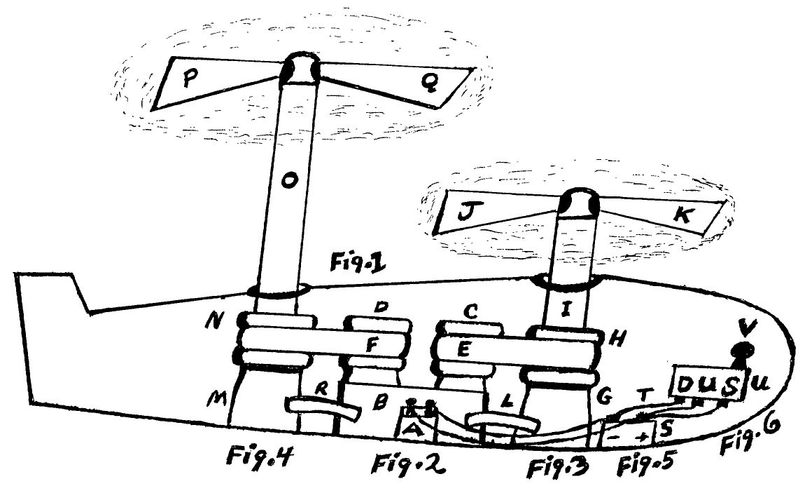

FIG. 1 is a view of an air plane.

FIG. 2 is a view of a the engine started, B is a view of the engine, C is a view of B front rotary wheel, D is a view of B rear rotary wheel, E is a view of FIG. 2C and FIG. 3H front rotary wheels belt, F is a view of FIG. 2D and FIG. 4N rear rotary wheels belt.

FIG. 3G is a view of the front hydraulic pressure tank, H is a view of G front rotary wheel conected to FIGS. 2C, E and FIG. 3H, I is a view of the front rotary shaft conected to FIGS. 3G and H, J and K FIG. 3 is a view of the front rotary propeller blades conected to FIG. 3I, L is a view of the front hydraulic pressure hose conected to FIG. 2B and FIG. 3G.

FIG. 4M is a view of the rear hydraulic pressure tank, N is a view of M rear rotary wheel conected to FIGS. 2D and F, O FIG. 4 is a view of the rear rotary shaft conected to FIGS. 4M and N, FIGS. 4P and Q is a view of the rear rotary propeller blades conected to O FIG. 4, R is a view of the rear hydraulic tank pressure hose conected to FIG. 2B and FIG. 4M.

FIG. 5S is a front view of the battery, FIG. 5T is a view of the electric wires conected to FIG. 2A, FIG. 5S and FIG. 6U.

FIG. 6U is a view of the electric control box, FIG. 6V is a front view of the electric control box handle.

On page number 2 is a view of FIG. 6V handle on the letter D is for downward position, on page number 3 FIG. 6V handle on the letter U is for upward position is also a view, on page number 4 FIG. 6V handle on the letter S is for starting position is also a view.

FIG. 2, FIG. 3, FIG. 4 and FIG. 5 all operate in conjunction with FIG. 6.

What I claim as my invention:

1. The propeller and air plane combination, as shown and set sixth,
FIG. 1 is a view of A, an air plane.
FIG. 2 is a view of B, is a bottom view of the engine started, C is a bottom center view of the engine, D is a front center view of the engine rotary wheel, E is a rear center view of the engine rotary wheel, F is a front center view of the engine rotary wheel belt, connected to FIG. 2D and FIG. 3H, G is a rear center view of the engine rotary wheel belt ,connected to FIG. 2E and FIG. 4O.
FIG. 3H, is a front view of the shaft rotary wheel, I is a front view of the hydraulic pressure tank, j is a front view of i rotary shaft, connected to H, K, L and FIGS. 2D and F, K and L is a top front view of the propeller blades, M is a bottom front view of the hydraulic pressure hose, connected to FIG. 2C and FIG. 3I.
FIG. 4N, is a rear view of the hydraulic pressure tank, O is a rear view of the rotary wheel, P is a rear view of the rotary shaft, connected to O, Q, R and FIGS. 2E and G, Q and R is a rear view of the propeller blades, S is a bottom rear view of the hydraulic pressure hose, connected to N and FIG. 2C.
FIG. 5T, is a bottom front view of the battery, U is a bottom front and center view of the electric wires.
FIG. 6V, is a front view of the electric control box, connected to FIG. 2B and FIG. 5T, W is a front view of the electric control box handle, FIG. 6 and W control the electric power and hydraulic pressure, for FIGS. 1, 2, 3, 4 and FIG. 5.
On page number 2, FIG. 6W handle on the letter D, is for downward position, on page number 3, FIG. 6W handle on the letter U, is for upward position, on page number 4, FIG. 6W handle on the letters, is for starting position.
